(19) United States
(12) Patent Application Publication
(10) Pub. No.: US 2005/0232817 A1
(43) Pub. Date: Oct. 20, 2005

(54) Functional on-chip pressure generator using solid chemical propellant

(75) Inventors: Chong H. Ahn, Cincinnati, OH (US); Chein-Chong Hong, Cincinnati, OH (US); Suresh Murugesan, Cincinnati, OH (US); Sanghyo Kim, Yongln (KR); Gregory Beaucage, Cincinnati, OH (US)

Correspondence Address: HAHN LOESER & PARKS, LLP, One GOJO Plaza, Suite 300, AKRON, OH, 44311-1076, US

(73) Assignee: The University of Cincinnati

(21) Appl. No.: 10/946,818

(22) Filed: Sep. 22, 2004

Related U.S. Application Data
(60) Provisional application No. 60/506,641, filed on Sep. 26, 2003.
(60) Provisional application No. 60/506,226, filed on Sep. 26, 2003.
(60) Provisional application No. 60/506,321, filed on Sep. 26, 2003.
(60) Provisional application No. 60/506,424, filed on Sep. 26, 2003.
(60) Provisional application No. 60/506,635, filed on Sep. 26, 2003.

(51) Int. Cl. B01L 3/00

(52) U.S. Cl. 422/99

(57) ABSTRACT

A functional on-chip pressure source using a solid propellant chemical material is disclosed which, upon heating to a critical temperature, liberates a precise amount of gas which, when liberated within an enclosed cavity coupled to a liquid in a microfluidic channel, raises the pressure and causes precise displacement of the liquid. The functional on-chip pressure source may be easily integrated with a disposable biochip, may be fabricated using low-cost, high volume manufacturing techniques, uses very low power, and may provide a dynamically variable output pressure across a broad spectrum of pressures. Embodiments of the present invention address significant challenges in the development of disposable microfluidic biochips including providing a reliable solution for pumping liquids in a microfluidic system and immediately applying the solution to a variety of microfluidic biochip applications.

### CROSS-REFERENCE TO RELATED APPLICATIONS

This application claims priority to provisional U.S. Patent Applications Ser. Nos. 60/506,641; 60/506,226; 60/506,321; 60/506,424; and 60/506,635 all filed on Sep. 26, 2003, and all of which are incorporated herein by reference in their entirety.

This patent application is being filed concurrently with U.S. Patent Applications having Ser. No. ______ attorney docket numbers 200057.00008, 200057.00009, 200057.00010, and 200057.00012, which are incorporated herein by reference in their entirety.

### TECHNICAL FIELD

Embodiments of the present invention generally relate to pumping mechanisms for microfluidic devices and more particularly to a no-moving part pumping system that uses an functional on-chip pressure generator using solid propellant, and more particularly, to gas release at low temperatures, precise and stable fluid driving, and a programmable pressure output by controlling applied power.

### BACKGROUND OF THE INVENTION

Most microfluidic systems for biochemical analysis are composed broadly of the following components: microchannels to guide fluid flow, microvalves to regulate fluid flow, micropumps to cause fluidic displacement and biosensors to detect relevant parameter. Furthermore, microfluidic systems may also contain specialized components such as biofilters or separators etc.

Micropumps are a critical component of the microfluidic system as they enable fluid flow within the microchannels and can be used to control the location and volume of fluids delivered or transmitted via a microchannel.

Some of the desirable characteristics for a micropump that are of relevance to integrated microfluidic systems and more specifically disposable, integrated microfluidic systems include: high pressure head, precise control of delivered pressure and/or flow rate, rapid response time, no leakage, no back flow, low power consumption, ease of fabrication, ease of integration with microfluidic system, dynamic pressure response, small size, and low cost.

The two main approaches used for pumping on the microscale are the use of reciprocating pumps and use of an electric field for driving partially conducting liquids. Most commonly, micropumps use a reciprocating diaphragm that can be actuated using a variety of techniques and examples of which are presented in US patents U.S. Pat. No. 6,408,878 and U.S. Pat. No. 6,109,889 incorporated herein by reference in their entirety and also as described in G. Kovacs, Micromachined Transducers Sourcebook, WCB-McGraw Hill, New York, 1998. The said micropumps can be fabricated using a variety of techniques and materials. Examples of micropumps using electro-osmotic principles i.e. the use of a high electric field for fluidic driving are presented in application WO 04007348 A1 and patent U.S. Pat. No. 6,033,546 incorporated herein by reference in their entirety.

However, both the above listed techniques suffer from serious drawbacks that have prevented universal adoption of said techniques as the preferred method for pumping fluids in microfluidic devices. Reciprocating micropumps usually require complex fabrication processes, are very energy inefficient, require large operating power, are susceptible to clogging, are susceptible to break down due to wear-and-tear of moving parts, cannot generate large pressures, are difficult to integrate with the microfluidic system, and are usually very expensive to manufacture. Electric field driven micropumps can only work with a limited range of liquids satisfying stringent requirements of conductivity and pH, require very high operating voltages that cannot be supplied for a portable microfluidic system, and are prone to clogging by bubble formation during pumping.

In addition to the two techniques listed above, another technique for pumping fluids in microfluidic systems is thermo-pneumatic pumping as disclosed in applications WO 03027508 A1, U.S. 20030234210 A1 and patents U.S. Pat. No. 5,375,979, and U.S. Pat. No. 6,130,098 incorporated herein by reference in their entirety. In thermo-pneumatic pumps, the liquid of interest is displaced by heating a gas in a pumping chamber and the expansion of the gas under heat is used to drive the liquid. Though these approaches address some of the issues listed above such as clogging or break down due to mechanical wear-and-tear, they do not address the power consumption issue.

Another novel approach, as disclosed in application WO 0188525 A1, is the use of compressed gas stored in a chamber and released explosively by burning a hole in a membrane surrounding part of the chamber. This approach requires low power but cannot deliver regulated pressure, which can be dynamically governed. Furthermore, the fabrication process for this approach is non-trivial and requires considerable skill and expertise.

A possible approach could include the use of a liquid propellant, which after ignition can release a large volume of gas and the gas can then be used for microfluidic manipulation. However, storing the liquid propellant on-chip is a non-trivial task and requires a complex liquid handling system and fabrication process.

As an alternative approach, solid-propellants have been used in microfabricated systems as disclosed in US patent U.S. Pat. No. 6,206,418 and European application EP 0903487 A2. U.S. Pat. No. 6,206,418 discusses the use of solid-propellants for air bag deployment purposes wherein a large volume of gas is liberated by heating a relatively small volume of solid-propellant. EP 0903487 A2 discusses the uses of solid propellant for space microthruster applications. For this particular application, the solid-propellant is stored in a cavity sealed by a thin diaphragm. Upon heating the solid-propellant, a large volume of gas is liberated that ruptures the thin membrane and releases the gas which provides an impulse thrust. However, in the applications listed above, very high temperatures (400° C. or higher) are required for triggering the gas release from the solid-propellant. For biochemical analysis systems, it is critical to ensure that the temperatures do not rise beyond the physiological range (typically 37° C.) or in some cases such as PCR reactions to higher temperatures (less than 100° C.). Most physiological liquids and samples of biochemical interest are water based and temperatures in excess of 100° C. would cause vaporization of the sample and complete denaturing/destruction of the biological specimens. Furthermore, at elevated temperatures, solid-propellants typically release toxic by-products in addition to the gaseous component. It is obvious that such components would adversely affect the biological samples.

### SUMMARY OF THE INVENTION

Based on the above discussion, it is readily obvious that there is clear need for new microfluidic pumping technique that can address some or all of the shortcomings listed previously. Recently, a novel functional on-chip pressure generator using solid chemical propellant for microfluidic pumping specifically towards disposable lab-on-a-chips been proposed and demonstrated by Chein-Chong Hong et al in “A Functional On-Chip Pressure Generator Using Solid Chemical Propellant for Disposable Lab-on-a-Chip”, Proc. of the 16th IEEE MEMS Workshop (MEMS '03), Kyoto, Japan, Jan. 19-23, 2003. This technique allows the fabrication of a functional or programmable on-chip pressure generator that addresses most of the shortcomings listed in the previous discussion. The pumping technique developed by Hong et al makes it possible to realize a dynamically programmable pressure source, which is capable of producing high pressure, has a very rapid response time, consumes very low energy for operation, is easy to fabricate and is fully integrated with the microfluidic system during fabrication, and is a low-cost approach.

To date, no known technique has been able to achieve the functional or programmable pressure characteristics with an easy and low-cost fabrication approach as made possible by the functional on-chip pressure source using solid-propellants. Techniques are disclosed herein for fabricating said functional on-chip pressure generator using solid-propellants and its application for disposable biochips.

We disclose herein a novel functional on-chip pressure generator using solid chemical propellant, one such solid propellant being azobis-isobutyronitrile (AIBN), and which can be fabricated as a fully integrated component of a microfluidic biochemical analysis system. Emnbodiments of the present invention overcome many of the disadvantages of the prior art by providing a functional on-chip pressure source using solid propellant that is small in size, easy to fabricate, more reliable (since it has no moving parts), low cost, a simple actuation/control circuit, less power consumption than conventional micropumps, and low-temperature release of gas.

Specifically, we disclose the use of a solid-propellant, which is normally in powder form, and a liquid matrix material in which the solid-propellant material is dispersed and subsequently deposited and cured onto a microfabricated heater. The matrix material serves a dual purpose: (a) it allows for precise quantities of solid-propellant to be deposited on-chip at predetermined locations using low-cost fabrication techniques and (b) it serves as a filter during gas evolution and only allows the gaseous component of the solid-propellant dissociation to escape. For use, a current pulse is applied to the heater causing a rise in temperature of the heater and the (solid-propellant+matrix) material on top. When the temperature reaches a critical or dissociation temperature a preset volume of nitrogen gas is released from the solid-propellant and this gas is used to push the liquid in microfluidic channels. The use of the matrix material allows for a simplified fabrication and low-cost, high volume fabrication techniques such as screen-printing can be used for the fabrication of the functional pressure generator.

We further disclose techniques to integrate this functional pressure generator with a microfluidic biochip using a straightforward and simple fabrication process. The functional pressure generator is ideally suited towards microfluidic control applications as the gas generated by the solid-propellant, which in turn governs the pressure, can be easily controlled by changing a number of parameters such as solid-propellant material, matrix material, heater material, heater resistance, ratio of solid-propellant to matrix materials, volume of the solid-propellant used, and area on which solid-propellant volume is deposited over the microheater. Furthermore, even after the fabrication process is complete, the pressure generated by the functional pressure generator using solid-propellant can be modulated by a wide range of control parameters such as temperature of the microheater, nature of a current pulse applied to the microheater, duration of a current pulse applied to the microheater, and by applying a series of discrete pulses instead of a steady current pulse. Control of the current characteristics can be achieved by any programmable electronic power source regulated from a computer using programs such as LabVIEW™ or by using a dedicated electronic controller.

In accordance with an embodiment of the present invention, the choice of the solid-propellant material is made such that, upon heating, a biologically inert gas, specifically Nitrogen, is released that will not react with any of the biochemical microfluidic samples. However, as will be readily apparent, the solid-propellant material can also be chosen such that it releases a reactive gas, for example oxygen, which can participate or catalyze a biological or chemical reaction.

Without intent of limiting the scope of applications of embodiments of the present invention, the functional pressure generator using solid-propellant can be easily fabricated on wide variety of substrate materials typically used for biochip applications such as Silicon, Silicon derived surfaces such as Silicon Dioxide, Silicon Carbide or Silicon Nitride, Glass, injection molded or embossed polymer substrate, polymer laminates or thin films, and ceramics. In fact, a significant advantage of the functional on-chip pressure generator using solid-propellant is that it can be realized on virtually any solid substrate that can withstand the dissociation temperature of the solid-propellant without adverse effects on its mechanical, chemical or other physical properties.

Herein are also disclosed techniques of using the functional on-chip pressure generator using solid-propellants to generate a spiked pressure response or a quasi-steady pressure response. The pressure response characteristics of the pressure generator can be dynamically modified by changing the characteristics of the current pulses used to drive the microheater.

Without intent of limiting the scope of application of embodiments of the present invention, the application of various embodiments of the present invention is generally a low-cost, disposable plastic biochip for biochemical analysis, where the functional on-chip pressure generator is used with passive microfluidic circuits to manipulate the sequence of flow on the biochip.

Certain embodiments of the present invention overcome the deficiencies and inadequacies in the prior art as described in the previous section and as generally known in the industry.

Certain embodiments of the present invention provide a functional or programmable on-chip pressure generator whose pressure response characteristics can be modified during and also after fabrication.

Certain embodiments of the present invention provide a solid chemical propellant, one example of which is AIBN (azobis-isobutyronitrile), to release nitrogen gas at low temperature on demand.

Certain embodiments of the present invention provide a pressure source to release nitrogen gas for biofluid actuation in disposable microfluidic-based biochips.

Certain embodiments of the present invention provide a screen-printing technique for mass production of this pressure source by dispersing the solid-propellant in the appropriate matrix material to achieve desired viscosity characteristics for screen-printing.

Certain embodiments of the present invention provide an on-chip pressure source to have functional pressure output by controlling applied electrical power to the micro igniter.

Certain embodiments of the present invention provide a microfluidic pumping technique with no-moving parts with programmable pressure delivery characteristics achieved using minimal control signals to develop a unique pumping method for disposable biochips.

Certain embodiments of the present invention provide a functional on-chip pressure source that can be fabricated as a fully integrated component of the microfluidic system.

Other features and advantages of various embodiments of the present invention will become apparent from the detailed description of various embodiments of the present invention when considered in conjunction with the accompanying drawings.

### BRIEF DESCRIPTION OF THE DRAWINGS

The present invention, as defined in the claims, can be better understood with reference to the following drawings and microphotographs of embodiments of the actual devices. The drawings are not all necessarily drawn to scale, emphasis instead being placed upon clearly illustrating principles of the present invention.

FIGS. 1a-1c are a schematic illustration of the operation of the functional on-chip pressure source using solid propellant, such as AIBN, for microfluidic manipulation and a detailed view of the on-chip pressure source, in accordance with an embodiment of the present invention.

FIGS. 2a-2b show the chemical decomposition mechanism for a solid propellant such as AIBN, and the loss of mass associated with gas evolution beyond the dissociation temperature, in accordance with an embodiment of the present invention.

FIGS. 3a-3b show the GS-MS (gas chromatography coupled with mass spectrometer) analysis of the compounds formed during dissociation of the solid-propellant at 70° C. and 105° C., in accordance with an embodiment of the present invention.

FIGS. 4a-4g show detailed fabrication steps of the solid propellant as an integrated component of the microfluidic device, in accordance with an embodiment of the present invention.

FIGS. 5a-5d show the assembly sequence of the solid propellant based actuator with the microfluidic device, in accordance with an embodiment of the present invention, and also the other possible assembly sequence/methods possible to couple the solid-propellant based functional on chip pressure generator to the microfluidic device.

FIGS. 6a-6c show the various configurations possible for positioning of the microheater for activating the solid propellant and the possible use of alternate actuation techniques such as IR radiations sources, in accordance with various embodiments of the present invention.

FIGS. 7a-7c show micro-photographic views of the functional on-chip pressure generator by itself and also as an integrated component of a microfluidic device, in accordance with various embodiments of the present invention.

FIGS. 8a-8c show conceptual illustrations showing the use of multiple solid-propellant actuator sources to control microfluidic manipulation including various microheater configurations and various configurations for solid-propellant housing cavity, in accordance with various embodiments of the present invention.

FIGS. 9a-9d show various configurations of the microheater that may be used to heat the solid propellant to its dissociation temperature, in accordance with various embodiments of the present invention.

FIGS. 10a-10d show a typical pressure response of the functional on-chip pressure generator actuated using steady state current of different magnitudes and also the possible current pulse configurations that may be used for dynamic modulation of the pressure response, in accordance with various embodiments of the present invention.

FIGS. 11a-11d show micro-photographs of a functional on-chip pressure generator using solid propellant integrated with a microfluidic device and being used to displace the liquid within the microchannel, in accordance with an embodiment of the present invention.

FIG. 12 shows the pressure response of a representative example of solid propellant, namely 3.2 mm×3.2 mm×150 μm AIBN, triggered using a microheater activated by varying magnitude of current to generate different pressure values, in accordance with an embodiment of the present invention.

FIG. 13 shows the pressure response of an representative example of solid propellant namely AIBN, in a well defined cavity (of 8 μl volume in this case) wherein the volume of AIBN stored in the cavity is directly proportional to the maximum realizable pressure within the cavity, in accordance with an embodiment of the present invention.

FIGS. 14a-14b illustrate the use of an air-vent in conjunction with the functional on-chip pressure generator to control the precise position of the microfluidic column, in accordance with an embodiment of the present invention.

### DETAILED DESCRIPTION OF THE INVENTION

Broadly stated, the various embodiments of the present invention provide a functional on-chip pressure source using a chemical solid propellant for applications in pumping fluids in a microfluidic system. Certain embodiments of the present invention disclose the use of a solid chemical propellant and a micro igniter for producing functional pressure output by releasing nitrogen gas on demand with different applied power.

A key concept disclosed herein is the use of precisely defined micro igniter and solid chemical propellant on a biocompatible plastic substrate to make a functional on-chip pressure source. When electrical power is applied to a micro igniter, it causes precise gas release and consequent increase in pressure that subsequently is coupled to a microfluidic column to achieve precise displacement of liquids within a disposable biochip.

Definitions

The process of “Microfabrication” as described herein relates to the process used for manufacture of micrometer sized features on a variety of substrates using standard microfabrication techniques as understood widely by those skilled in this art. The process of microfabrication typically involves a combination of processes such as photolithography, wet etching, dry etching, electroplating, laser ablation, chemical deposition, plasma deposition, surface modification, injection molding, hot embossing, thermoplastic fusion bonding, low temperature bonding using adhesives and other processes commonly used for manufacture of MEMS (microelectromechanical systems) or semiconductor devices. “Microfabricated” or “microfabricated devices”, as referred to herein, refers to the patterns or devices manufactured using the microfabrication technology.

The term “chip”, “microchip”, or “microfluidic chip” as used herein means a microfluidic device generally containing a multitude of microchannels and chambers that may or may not be interconnected with each another. Typically, such biochips include a multitude of active or passive components such as microchannels, microvalves, micropumps, biosensors, ports, flow conduits, filters, fluidic interconnections, electrical interconnects, microelectrodes, and related control systems. More specifically the term “biochip” is used to define a chip that is used for detection of biochemically relevant parameters from a liquid or gaseous sample. The microfluidic system of the biochip regulates the motion of the liquids or gases on the biochip and generally-provides flow control with the aim of interaction with the analytical components, such as biosensors, for analysis of the required parameter.

The term “microchannel” as used herein refers to a groove or plurality of grooves created on a suitable substrate with at least one of the dimensions of the groove in the micrometer range. Microchannels can have widths, lengths, and/or depths ranging from 1 μn to 1000 μm. It should be noted that the terms “channel” and “microchannel” are used interchangeably in this description. Microchannels can be used as stand-alone units or in conjunction with other microchannels to form a network of channels with a plurality of flow paths and intersections.

The term “microfluidic” generally refers to the use of microchannels for transport of liquids or gases. A microfluidic system includes a multitude of microchannels forming a network and associated flow control components such as pumps, valves and filters. Microfluidic systems are ideally suited for controlling minute volumes of liquids or gases. Typically, microfluidic systems can be designed to handle fluid volumes ranging from picoliter to milliliter range.

The term “substrate” as used herein refers to the structural component used for fabrication of the micrometer sized features using microfabrication techniques. A wide variety of substrate materials are commonly used for microfabrication including, but not limited to; silicon, glass, polymers, plastics, ceramics to name a few. The substrate material may be transparent or opaque, dimensionally rigid, semi-rigid or flexible, as per the application they are used for. Generally, microfluidic devices comprise at least two substrate layers where one of the faces of one substrate layer contains the microchannels and one face of the second substrate is used to seal the said microchannels. The terms “substrate” and “layer” are used interchangeably in this description. Specifically, in accordance with various embodiments of the present invention, the substrate is a material that can withstand the thermal dissociation temperature of the solid-propellant materials.

The term “UV-LIGA” describes a photolithography process modeled on the “LIGA” fabrication approach. LIGA refers to the microfabrication process for creating microstructures with high aspect ratio using synchrotron radiation and thick photoresists (ranging in film thickness from 1 μm to 5 mm). The LIGA process is used to form a template that can be used directly or further processed using techniques such as electroplating to create the microfluidic template. UV-LIGA uses modified photoresists that can be spin coated in thicknesses of 1 μm to 1 mm and are sensitive to UV radiation. UV radiation sources are commonly used in microfabrication facilities and hence Uv-LIGA offers a lower cost alternative to LIGA for fabrication of high aspect ratio microstructures.

The term “master mold” as used herein refers to a replication template, typically manufactured on a metallic or Silicon substrate. The features of the master mold are fabricated using the UV-LIGA and other microfabrication processes. The microstructures created on the master mold may be of the same material as the master mold substrate e.g. Nickel microstructures on a Nickel substrate or may be a dissimilar material e.g. photoresist on a Silicon surface. The master mold is typically used for creating microfluidic patterns on a polymer substrate using techniques such as hot embossing, injection molding, and casting.

The term “bonding” as used herein refers to the process of joining at least two substrates, at least one of which has microfabricated structures e.g. microchannel, on its surface to form a robust bond between the two substrates such that any liquid introduced in the microchannel is confined within the channel structure. A variety of techniques can be used to bond the two substrates including thermoplastic fusion bonding, liquid adhesive assisted bonding, use of interfacial tape layers, etc. Specifically in this description the terms “bonding” and “thermoplastic fusion bonding” are used interchangeably. Thermoplastic fusion bonding involves heating the two substrates to be joined to their glass transition temperature and applying pressure on the two substrates to force them into intimate contact and cause bond formation. Another bonding process, namely the use of UV-adhesive assisted low temperature bonding, is also described herein and is specifically and completely referred to in all occurrences.

The term “microheater”, “heater”, “igniter” and “micro-igniter” as used herein, refers to a microfabricated heater pattern which is created by depositing a metal layer on a suitable substrate and using microfabrication techniques to define a continuous metal track of precise dimensions from the deposited metal layer. The metal track serves as a resistive heater wherein the passage of current through the metal tracks or electrodes causes a rise in temperature of the metal electrodes due to the process of resistive heating. The terms “heater”, “microheater”, “igniter” and “micro-igniter” are used interchangeably and generally refer to the resistive heater unless specifically described otherwise.

The term “current pulse” or “pulse train” as used herein describes a single or plurality of precisely defined changes in current over a period of time delivered to the microheater. The current pulse can be created by any electronic controller coupled to a power supply or by designing a specific power supply to deliver the desired current characteristics. Furthermore, a wide variety of current pulses can be created by commonly available controllers such as the square wave pulse, half-square wave pulse, sine wave pulse, half-sine wave pulse, triangular pulse, and half-triangular pulse. Note that generally current pulse refers to a positive as well as negative variation in the magnitude of the current and half pulse refers to only a positive current variation.

The term “solid-propellant” as used herein refers to any material that can liberate a substantial volume of gas upon direct heating. The liberated gas may be biochemically reactive such as Oxygen or a biochemically inert gas such as Nitrogen. A wide variety of solid-propellants are available commonly with varying properties in terms of physical structure i.e. liquid or solid, chemical composition, dissociation temperature, chemical structure of released gas, volume of released gas and so on. The choice of a suitable propellant is governed by a number of factors such as chemical nature of the evolved gas, volume of evolved gas, dissociation temperature, toxicity or lack thereof of the gaseous and non-gaseous components after dissociation. In this description, azobis-isobutyronitrile (AIBN) is described as one solid-propellant, however it is understood that any suitable solid-propellant that matches the characteristics stated above for the given application can be substituted instead of AIBN and the scope of this invention is not limited to this particular material.

The term “thermal dissociation” as used herein, refers to the chemical breakdown of a solid propellant material specifically after application of heat with concurrent liberation of a substantial volume of a gaseous product. The “dissociation temperature” is generally a range of temperature, rather than a precisely defined temperature, over which the thermal dissociation process occurs. Depending on the material of the solid-propellant the range over which dissociation and gas evolution occurs generally spans a temperature range approximately 10 to 60° C. beyond a minimum dissociation temperature. Most solid-propellants have a “primary dissociation temperature” and a “secondary dissociation temperature” or “breakdown temperature”. The terms “dissociation temperature” is generally used to describe the “primary dissociation temperature” in this description. The “secondary dissociation temperature” refers to a range of temperature typically higher than the “primary dissociation temperature” at which the non-gaseous components left behind after primary dissociation are further broken down due to heat. Specifically for this application, heating solid propellants to the “secondary dissociation temperature” is generally undesirable since no additional gas is evolved and more energy is required to reach the secondary dissociation temperature.

The term “matrix” as used herein, describes a material that can physically entrap solid or liquid solid-propellant particles without allowing them to escape freely. Furthermore, the matrix material simultaneously exhibits a high porosity for gaseous components such that the gas evolved after heating the solid-propellant material can easily escape the matrix material. In addition, the matrix material should not be chemically reactive with the solid propellant. Also, the matrix material should be able to retain the desired physical characteristics at the dissociation temperature of the solid-propellant.

The term “micropump” as used herein, refers to a device or arrangement that can provide force for displacement of liquids or gases entrapped within a microchannel. A wide variety of pumping mechanisms are known in the art and specifically in this description the “micropump” is of a positive displacement type wherein the pump generates a positive pressure, above the atmospheric pressure, and the higher pressure is coupled to one of a microfluidic column via suitable fluidic interconnects and microchannels. The differential pressure causes movement of the liquid plug or column. An “integrated micropump” or “integrated pressure source” or “on-chip micropump” or “on-chip pressure source” as used herein, refers to a micropump configuration that it is irreversibly attached or is an integral part of the microfluidic chip. The above listed terms are used interchangeably in this description.

The “functional on-chip pressure generator” or “functional pressure generator” or “functional on-chip pressure generator using solid-propellant” as used herein, are used interchangeably, and refer to a positive pressure source whose output, i.e. the pressure, can be dynamically regulated after the pressure source has been fabricated and assembled or integrated with the biochip.

The intent of defining the terms stated above, is to clarify their use in this description and does not explicitly or implicitly limit the application of this invention by modifications or variations in perception of said definitions.

Functional On-Chip Pressure Generator (micro-propulsion system) Using Solid-Propellant

The goal of various embodiments of the present invention is to develop an easily manufactured, fully integrated pumping scheme for microfluidic devices to mobilize any fluid within a microchannel structure. Also the pressure generated to mobilize the fluids can be precisely controlled by the applied electric power. This approach gives the user better control over the amount of fluid to flow, and when the liquid should flow. The power consumption is significantly lower compared to the other known pressure generators. This method allows the user to fabricate a functional on-chip pressure generator in a number of forms such as films, sheets and paste mixture along with an inert polymer.

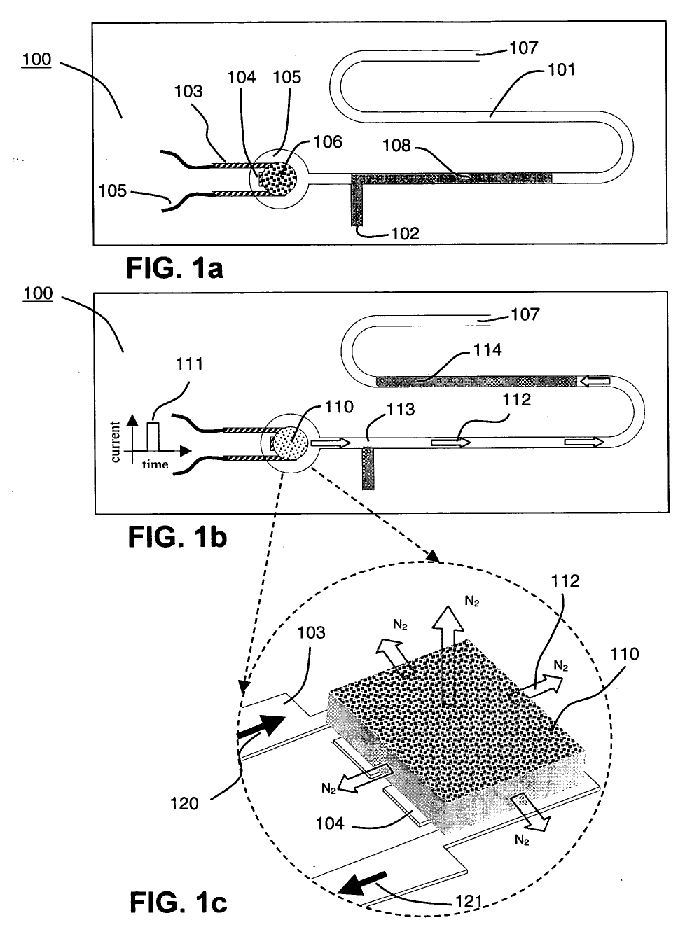

FIG. 1a and FIG. 1b show a schematic sketch explaining the operation of the functional on-chip pressure generator (i.e., micro-propulsion system). FIG. 1a shows the basic schematic where a liquid 108 is introduced via a liquid inlet 102, into a microchannel 101. A solid propellant entrapped within a matrix material 106 is deposited onto a microheater structure 104 within a precisely defined cavity 105. A precisely controlled amount of electrical energy 111 is supplied to the microheater 104 via low resistance electrical tracks 103 and conductors 105 connected to an electronic circuit. When, the solid propellant 106, is heated to its dissociation temperature it will release a controlled amount of gas 112. One end of the liquid column is at atmospheric pressure through the outlet port 107. The applied pressure because of the evolved gas 112 causes a differential pressure across the liquid column 114 causing it to split at the junction point 113, and flow away from the pressure source as shown in FIG. 1b. FIG. 1c shows a detailed view of the functional on-chip pressure generator. FIG. 1c also shows that the gas evolution is omni-directional through the solid propellant/matrix and the pressure is directed to the liquid column using suitable microchannel design. The velocity, final position and volume of displacement of the liquid column can be easily controlled by changing the width of the applied current pulse 111. A longer current pulse will lead to more heating and more gas evolution hence more pressure and subsequent displacement of the liquid column. Specifically, as shown in FIGS. 1a-1c, the on-chip pressure generator is operating in an open loop configuration. Alternately, a pressure sensor can be connected to the cavity housing the solid propellant film and the input current pulse can be modified by the pressure feedback signal within the solid propellant cavity to release an accurate feedback control loop for generated gas volume and hence delivered pressure.

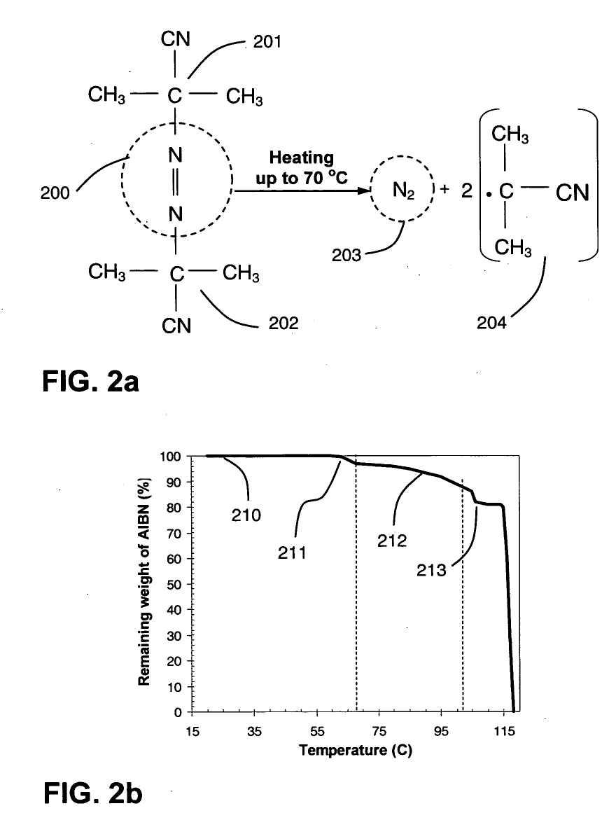

In accordance with an embodiment of the present invention, the solid propellant material is AIBN. AIBN has a dissociation temperature of approximately 68° C. The chemical structure of AIBN which has two (CH₂)—C—CN, 210 and 202, groups linked by two Nitrogen atoms 200 is shown in FIG. 2a. The applied heat causes a chemical breakdown of the AIBN structure and Nitrogen gas 203 and two free radicals (CH₂)—C—CN 204 are formed. In this particular case a biologically inert gas, Nitrogen, is released upon dissociation of AIBN as shown in FIG. 2a.

For AIBN, like most solid propellants the dissociation temperature is not sharply defined and gas evolution occurs over a range of temperatures. FIG. 2b shows TGA (thermogravimertic) analysis results of AIBN decomposition at various temperatures. TGA analysis is used to calculate the fraction of mass loss in AIBN volume due to dissociation. As shown in FIG. 2b there is no weight loss in AIBN mass from approximately room temperature 210 to 65° C. 211. Beyond 65° C., typically starting at approximately 68° C., AIBN dissociation begins with increasing amount of nitrogen gas evolution. In the range from 68° C. to approximately 100° C., about 17% of AIBN weight is lost as the formed Nitrogen escapes. Beyond approximately 100° C., a sharp drop in weight is seen as more decomposition of the AIBN material, specifically the free radicals, occurs.

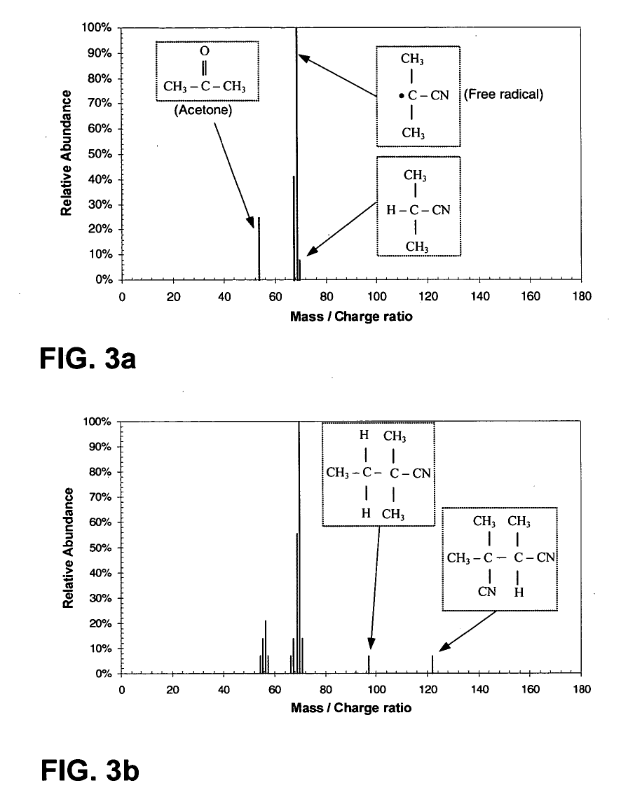

FIGS. 3a and 3b show GC-MS (gas chromatography in association with mass spectrometry) analysis of the AIBN dissociation process. For GC-MS analysis, about 0.1 ml of AIBN in acetone is injected into the GC-MS equipment nozzle while the nozzle temperature is maintained at desired temperatures. FIG. 3a shows the GC-MS spectra at approximately 70° C. showing the primary dissociation. The dissociated compounds pass through the GC column and through the MS before going to the detector. Individual components are identified based on their mass/charge ratio. As shown in FIG. 3a the peaks for acetone and the free radicals show up clearly. Nitrogen is not seen in this spectrum, as the mass/charge ratio of Nitrogen is below the detection limit of the particular equipment used for this analysis. FIG. 3b shows the GC-MS spectra at a temperature of 105° C. The primary peak corresponding to the free radicals shows up as decreased magnitude and several secondary peaks are seen indicating that further fragmented species are formed. Hence, based on the GC-MS and TGA analysis it is desirable to control the temperature of AIBN in the range of 65° C. to 100° C. to ensure that all the Nitrogen component of AIBN can be released with minimum applied power.

For most biochip application, where the released Nitrogen gas is used to push a biochemical sample, it is of interest that the pressurizing gases not react with the biochemical sample. Nitrogen is abundantly present in the normal atmosphere and has minimal to absolutely no reactivity with most biochemical samples and physiological fluids. Furthermore, it is desirable that the temperature of the evolved gas be less than 100° C. in order to ensure that heat transfer from the gas to the liquid does not cause vaporization of the liquid sample. Finally, in a preferred embodiment, the functional on-chip pressure generator is fabricated on a disposable biochip fabricated on a low-cost plastic substrate. The dissociation temperature of the solid-propellant material should be low enough that it does not cause mechanical failure of the substrate material. Considering all the above issues, in this embodiment, AIBN is used as the solid-propellant material.

There are number of solid propellant materials well known in the art. For example, AIBN is part of the so-called “azo compound family” and other compounds in this family include ADVN [2,2′-Azobis-(4-methoxy-2,4-dimethylvaleronitrile)], AMBN [2,2′-Azobis-(2-methylbutyronitrile)], and ACHN or ACCN [1,1′-Azobis-(cyclohexanecarbonitrile)]. These compounds have a dissociation temperature ranging from room temperature (approximately 20° C.) to 85° C. The list of azo-compounds provided above can typically be diluted by dissolution in a range of organic solvents such as chlorobenzene. The azo-compound family also includes materials which are water soluble such as ABAH [2,2′-Azobis-(2-methylbutyronitrile)] and ACVA [1,1′-Azobis-(cyclohexanecarbonitrile)].

In addition to the azo-compound family there are also a variety of other chemical compounds that can be used as solid-propellants. As described in C. Rossi et al, Sensors and Actuators A, 99, 2002, 125-133; a mixture of a binder (polybutadiene or glycidyle azide polymer), an oxidizer (NH₄ClO₄), and a fuel component (Al, Zr, B, or Mg) can also be used as a solid-propellant. Yet another solid propellant is described in W. A. de Groot et al., in AIAA Paper, 1998, 3225; is the composite propellant (2-methyl(1234-tetraazol-5-yl)nitroamine with a primary decomposition temperature of approximately 440465K. Yet another material described in L. Massa et al., Combustion Theory and Modeling, 7, 2003, 579-602; is another composite propellant with a mixture of Ammonium Perchlorate (AP) and hydrozy-terminated polybutaniene (HTPB). Yet another propellant is described in N. Bakhman et al., Physics of combustion and explosion, 6, 1970, 93; as a composite of Aluminum powder, AP and bitumen. Yet another solid propellant material could be as described in V. Simonenko et al., 29^{th} Int. Annual conf. of ICT 1999, 21; which is a composite propellant combining Al powder, HMX (cyclotetramethylene tetranitramine), and AP. Yet another solid propellant is also described in P. Lessard et al., 32^{nd} Int. Annual conf. of ICT 2001; which is another composite propellant with GAP/AN (glycidyl azide polymer.ammonium nitrite) and Alex powder. As can be readily imagined, a wide variety of material can be envisaged for use as solid-propellants offering a wide variety of physical, chemical and thermal properties.

In accordance with an embodiment of the present invention, the solid propellant material is one which liberates a biochemically inert gas such as nitrogen. In another embodiment, it is envisaged that, in addition to the fluidic displacement, the gaseous product of solid-propellant decomposition is a biochemically active gas such as oxygen which affects the outcome of a biochemical reaction by its presence.

In yet another embodiment, the solid propellant material has a low primary dissociation temperature (less than 100° C.) such that the temperature of the liberated gas will never exceed boiling point of most physiological liquids. In still another embodiment, a high temperature solid propellant material (with dissociation temperature in the range of 75° C. to 500° C.) is used wherein the evolved gas is also used to heat to the fluid it is displacing.

In one embodiment, it is envisaged that the solid-propellant material can be compressed to form pellets that can be directly positioned within microcavities and over a microheater structure. In another embodiment, it is envisaged that the solid-propellant material is a fine powder which will be mixed with a suitable binder material and then compressed to form the pellets described above. In yet another embodiment, the powder form solid-propellant would be suspended within a liquid matrix material, a precise volume of the suspension can then be deposited onto the microheater structure. As is readily apparent, there is a wide variety of approaches that may be followed based on the physical characteristics of the solid propellant material that can be used to fabricate the on-chip pressure generator.

An intended application for the functional on-chip pressure generator is for microfluidic manipulation within a low-cost, disposable biochip. A requirement to maintain the low-cost criteria is the use of a mass-manufacturing technique for the fabrication of all components of the biochip and specifically, as relates to this invention, that of the functional on-chip pressure generator. One such technique that is well known in the art is screen printing. For screen printing, the material to be deposited is generally a liquid of well defined viscosity. In order to screen print the solid propellant material, it is mixed with another matrix material.

The matrix material serves multiple purposes for the fabrication of the on-chip pressure source. The liquid material can be solidified at low temperatures by curing it at room temperature under normal atmospheric conditions. The solid propellant is mixed with a suitable matrix material and combination can then be screen printed to form precise patterns over a desired location on the biochip. The matrix material thus allows for the use of mass-manufacturing techniques such as screen printing and also provides a stable support for the solid propellant particles in order to ensure that they do not move from the desired location due to mechanical shock.

The criteria for selecting the material include: the matrix material should be initially in a liquid form and upon deposition in a thin layer should cure rapidly to form a solid film at low temperatures, specifically at temperatures lower than the dissociation temperature of the solid propellant. Upon curing the matrix material should form a sufficiently dense film that the solid propellant particles can be trapped effectively without being dislodged by mechanical shocks. Furthermore, the matrix material film should exhibit good adhesion to the solid propellant, the microheater metal layer and also the substrate layer. Also the matrix+solid propellant film should have low mechanical strength such that upon dissociation the gaseous components of solid propellant dissociation can easily escape. In addition the matrix material should not chemically react with the solid propellant material at room temperatures or elevated temperatures corresponding to the dissociation temperature of the solid-propellant. Furthermore, the matrix material should demonstrate sufficient chemical inertness such that it will not react with the solid components of the solid propellant left behind after the gas has escaped. If the matrix material does react with the solid propellant dissociation by products it should not produce any components that will interfere in any way with the biochemical reaction of interest. Although the matrix material can be a thermoplastic or a thermoset material, it should not degrade at temperatures approximately close to the dissociation temperature of the solid propellant. Specifically, for a thermoplastic matrix material, the deposited film should not melt at the dissociation temperature of the solid propellant. Finally, the matrix material in its liquid form should be a material whose viscosity can be adjusted by addition suitable binder or solvents to achieve the desired viscosity for the fabrication process such as screen printing.

Despite the exhaustive list of criteria listed above, a number of candidate materials are suitable as the matrix. The choice of the matrix material is also affected by the type of fabrication process used for the on-chip pressure generator. A list of some of the material that can be used includes, but not limited to, spin-on TEFLON™, spin-on silicone, PDMS (poly-dimethylsiloxane), spin on PMMA (poly-methylymethaacrylate), other spin-on polymers such as COC (cyclic olefin copolymer dissolved in toluene), positive and negative photoresist materials, and various epoxies.

In accordance with an embodiment of the present invention, a solid propellant material; AIBN is mixed with a spin-on TEFLON™; specifically CYTOP™. The Teflon matrix material satisfies all the criteria listed above for a suitable matrix material. In this embodiment, AIBN and CYTOP™ are mixed in 1:3 ratio by weight. Changing the mixing ratio will affect the amount of AIBN trapped in the CYTOP™ film and consequently the volume of Nitrogen gas generated upon dissociation. The mixing ratio for solid propellant to matrix can be changed in the range of 10:1 to 1:10 by weight, to achieve the desired pressure response characteristics and also the desired mechanical properties for the fabrication process.

For a given mixing ratio, for example, in the embodiment where solid propellant to matrix ratio is 1:3, the volume of gas generated by maintaining the dissociation temperature for a fixed interval of time can be changed by changing the volume of the deposited mixture, the area of the microheater over which the given volume is deposited, the thickness of the mixture film after curing and the geometrical shape of the deposited mixture. Obviously increasing the volume of the mixture (deposited over a larger heater area) allows for more nitrogen to be generated and hence higher pressures can be achieved. By depositing a given volume of the mixture over microheaters with different areas, the thickness of the deposited film can be controlled. In a thinner film, the heat transfer from the microheater to the solid propellant within the deposited film is faster leading to faster response times and higher gas volume evolution and higher generated pressures. Typically, the area of the deposited AIBN+CYTOP™ film ranges from 100 μm×100 μm to 5 mm×5 mm. The typical thickness of the AIBN+CYTOP™ film varies from 1 μm to 1 mm and the deposited volume of the mixture for the various configurations ranges from 0.01 mm³ to 10 mm³.

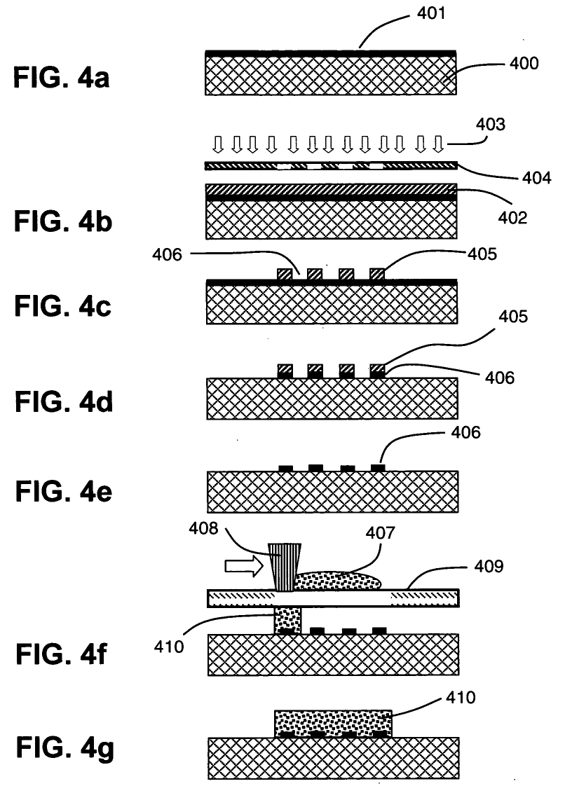

FIGS. 4a-4g show an embodiment of a fabrication process for the functional on-chip pressure generator using solid propellant. Initially a metal layer 401, is deposited on a suitable substrate material 400, as shown in FIG. 4a. Next, a layer of negative photoresist 402 is deposited on the metal film, typically using spin-coating, as shown in FIG. 4b. Then the photoresist is exposed to UV-radiation 403 through a suitable photomask 404 and the exposed photoresist is developed in a suitable developer to retain photoresist in the exposed areas 405, and washed out to expose the underlying metal layer in the unexposed areas 406, as shown in FIG. 4b and FIG. 4c. Note that the location of the resist areas and cavities can be reversed by using a positive photoresist. The metal layer is etched in the exposed areas using a suitable etching solution, and the photoresist is removed to leave behind the microheater 406 and connection pads pattern, as shown in FIG. 4d and FIG. 4e. This biochip layer is then aligned with a screen-printing mask 409 and the solid propellant+matrix mixture 407 is screen printed in precise areas (over the microheater) using a squeegee, as shown in FIG. 4f. After screen printing, the chip is cured at the appropriate temperature for a given time to form a solid, stable film of the matrix+solid propellant mixture over the microheater pattern in order to realize the functional on-chip pressure generator using solid propellant 410, as shown in FIG. 4g.

It should be noted that alternate processes compatible with microfabrication can also be used to realize the on-chip pressure source. For example, in one approach, a second thick photoresist mold can be created on top of the microheater pattern with opening where the solid propellant+matrix mixture is to be deposited. Following this, the mixture can be deposited within the cavity using techniques such as bumper filling, dip coating, spin coating, or spray coating. After curing the solid propellant+matrix mixture, the thick photoresist mold is dissolved in a suitable-remover to generate the on-chip pressure source. In yet another approach, following the fabrication of the microheater pattern, step 4e, the matrix+solid propellant mixture can be directly dispensed on to the heater area using a suitable dispensing mechanism. The latter approach does not allow for fabrication of arbitrary shapes of the deposited films and only approximately semi-spherical films can be generated using this method.

As is readily apparent from the fabrication sequence, the process is suitable for use with most commonly used substrates in microfabrication techniques. Some of the substrate materials that can be used include, but not limited to, Silicon or a derived Silicon surface such as Silicon dioxide or Silicon Nitride, glass, quartz, ceramics, a wide variety of polymers such as PDMS, PMMS, PC, COC, or a combination of listed substrates such as a glass substrate with a coated film of PMMA on the surface. In accordance with an embodiment of the present invention, a low-cost plastic surface is used for fabricating the on-chip pressure source for a disposable biochip. The substrate material can have thickness ranging from 100 μm to 5 mm. The thickness of the substrate material should be sufficient to impart dimensional stability required for the various steps of the microfabrication process. Generally, it is desired that the surface have a hydrophobic surface characteristic specifically for creating well defined patterns using the screen printing technique or direct deposition using dispensing schemes. The surfaces of the above listed substrates can be easily modified by a variety of surface modifications techniques such as plasma treatment, plasma deposition, covalent cross-linking etc. that are well known in the art. If the fabrication processes with a second thick photoresist mold is used it is envisaged that the surface energy of the substrate would not have a significant impact on the deposited pattern which would be defined by the cavity within the photoresist mold. Depending on the application, the biocompatibility characteristics of the substrate may be an important factor in determining choice of substrate material. Broadly stating, any substrate material that can be handled using established microfabrication processes, which exhibits good adhesion to metals and the solid propellant+matrix mixture can be used.

In addition to the substrate material, there is considerable flexibility in the choice of metal film for microheater fabrication. In accordance with an embodiment of the present invention, a 3000 Angstrom thick film of gold is directly deposited over the plastic material. The list of metals that can be used for this application include all metals that are commonly accepted for microfabrication and whose processing parameters are well established in the art. Also, a combination of metal films can be used to control the resistance and/or adhesion properties of the microheater pattern. Specifically, the resistance of the metal film is inversely related to the film thickness and can be controlled to achieve the required resistance.

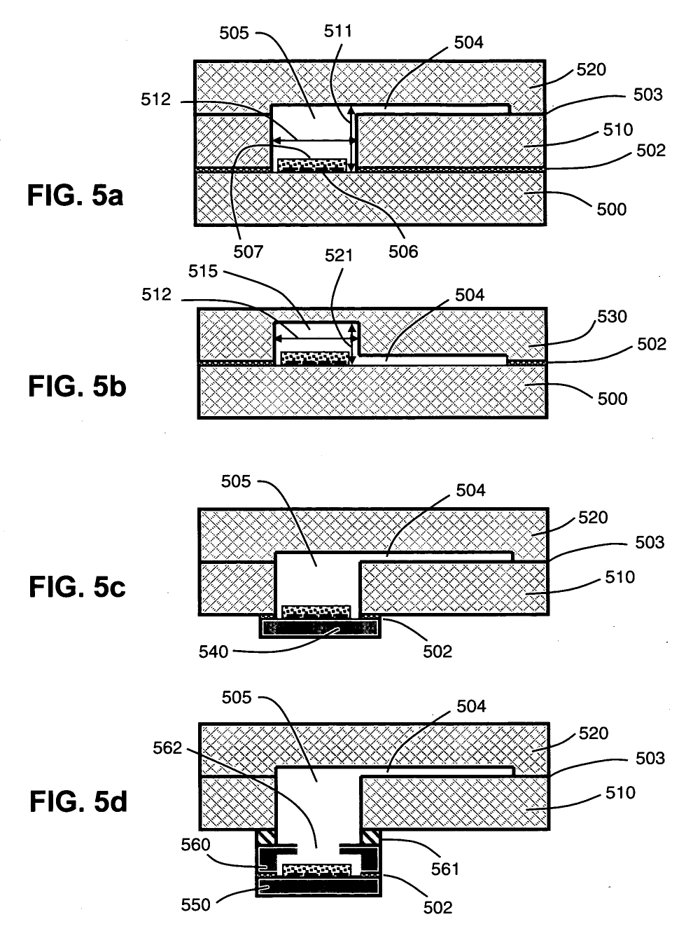

FIGS. 5a-5d show various schemes that can be used for integrating the functional on-chip pressure source with the disposable biochip. As shown in FIG. 5a, in one embodiment the biochip consists of three layers with the microfluidic channels 504 located on the topmost channel 520. The middle layer 510 serves to seal the microchannels 504 and also has a cavity 505 to contain the deposited solid propellant film. The cavity 505 extends through the entire thickness of the middle layer and provides a fluidic connection between the solid propellant film and the microchannel. Furthermore, the cavity may be cylindrical or square or rectangular in cross-section or it may have an arbitrary shape defined using microfabrication techniques. The width 512 and height 511 of the cavity are designed based on the area of the solid propellant film and the thickness of the middle layer respectively. The solid propellant film 507 is deposited on a microheater pattern 506 on the surface of the bottom layer 500. In accordance with an embodiment of the present invention, the top 520 and middle layers 510 are bonded 503 using thermoplastic fusion bonding. Alternately, any of well known bonding techniques such as adhesive or epoxy assisted bonding, surface welding, microwave assisted bonding, and tape bonding etc. may be used. The bottom layer 500, is assembled to the two top layers using a low temperature bonding technique. The temperature of the assembly technique should be at least 25° C. lower than dissociation temperature of the solid propellant. In one approach, UV-adhesive assisted bonding is used for assembly as shown in FIG. 5a. An interfacial layer of UV-adhesive 502 is deposited and after the two substrates are brought in contact, the adhesive is exposed to Lw-radiation for curing and cross-linking of the adhesive.

In another embodiment, the microchannel 504 and the solid propellant film housing cavity 515 are defined on the same layer 530. In this case, the height 521 of the cavity 515 is less than the thickness of the top layer 530 but greater than the thickness of the solid propellant film. The solid propellant and microheater combination are on the bottom layer 500 and coupled to the cavity/microchannels using low temperature assembly techniques, as shown in FIG. 5b.

In yet another embodiment, the on-chip pressure source can be fabricated on a substrate 540 which may be dissimilar in terms of material and/or dimensions to the other layers. The on-chip pressure generator can be a separate module that can be coupled to the microfluidic chip directly using low temperature assembly techniques, as shown in FIG. 5c.

In yet another embodiment, the on-chip pressure source is manufactured separately using a base 550 and a sealing layer 560 assembled using low temperature bonding techniques. The sealing layer has a cavity 562, which may be equal to or smaller in area than the solid propellant pattern. The on-chip pressure source can then be coupled to the biochip using either low temperature assembly techniques or by using air-tight sealing rings/washer 561 and a mechanical clamping arrangement.

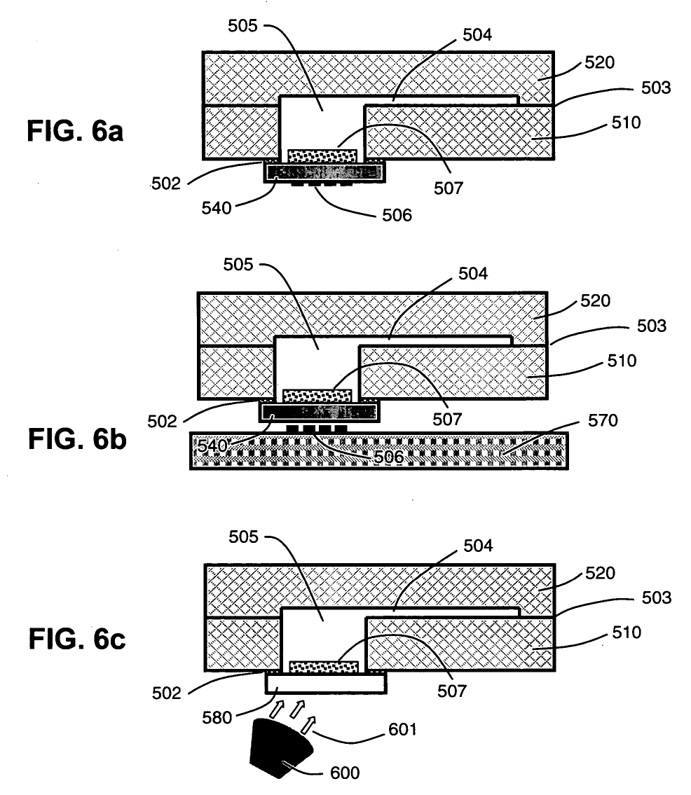

FIGS. 6a-6c show certain various envisaged configurations possible for microheater positioning. In one embodiment, as shown in FIG. 6a, the microheater 506 is positioned on the opposite surface of the substrate 540 with reference to the solid propellant film 507. For this embodiment, it is desired that the substrate 540 have good thermal conductivity to efficiently couple the heat from the microheater to the solid propellant. Such substrates could include Silicon or metals with dielectric coating. This arrangement offers the advantage of considerably simplifying electrical connections to the microheater which are now positioned on an “open” surface of the biochip.

In another embodiment, the microheater is separated from the biochip and positioned on a separate substrate 570 altogether, as shown in FIG. 6b. The biochip is brought in intimate contact with the outside substrate to promote efficient heat transfer through a high thermal conductivity layer 540. This arrangement further simplifies the electrical connectivity issues and also helps to reduce the cost of the biochip by eliminating the heater fabrication sequence from each biochip. In this arrangement, the heater can be re-used for multiple biochips without any loss of function.

In yet another embodiment, the microheater is eliminated altogether and ignition of the solid propellant is achieved by a non-contact method as shown in FIG. 6c. A variety of non-contact heating methods can be envisaged that can trigger the solid propellant. In one approach, a laser source can be used to rapidly heat up the solid propellant material which is deposited on a substrate 580, which is transparent to the laser wavelength. In another approach, the matrix material of the solid propellant film or the solid propellant material itself can have high absorbance of IR radiation and a suitable wavelength IR source can be used for ignition. In yet another approach, the substrate material 580, can be chosen to strongly absorb certain microwave wavelengths and a suitable microwave source can be used for indirect heating. In yet another embodiment, the entire biochip is heated within a controlled temperature environment to trigger the solid propellant. As is readily apparent from this description, there exist a wide variety of heating options which can be used for triggering or ignition of the solid propellant and all reasonably envisaged techniques are incorporated within the scope of the present invention.

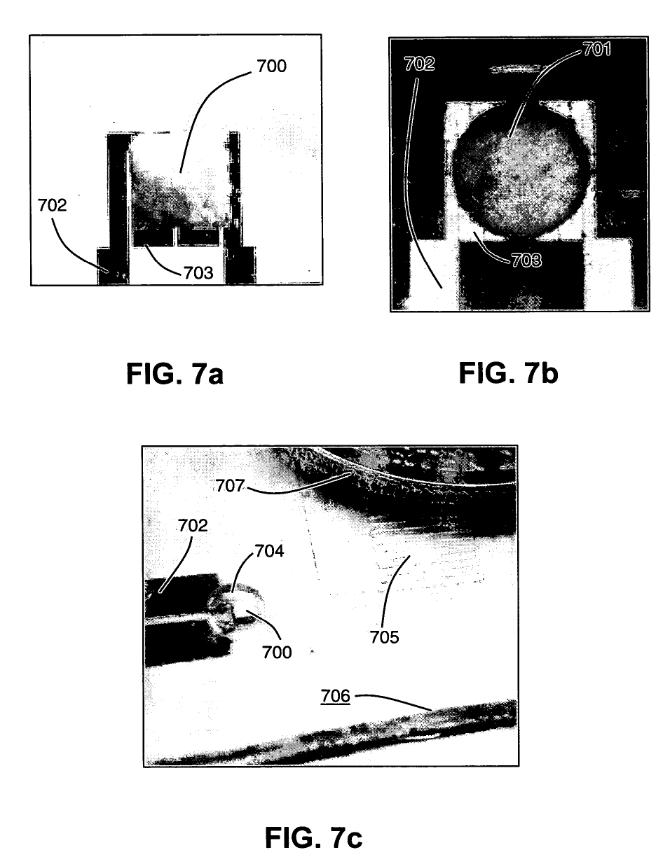

FIGS. 7a-7c show microphotographs of actual fabricated functional on-chip pressure generators. FIGS. 7a and 7b illustrate the different configurations of the microheater patterns 703, and the shape and size of the screen printed solid propellant film 701. FIG. 7c shows a functional on-chip pressure source 700 integrated with a microfluidic chip 706 wherein the cavity 704 housing the solid propellant also serves as coupling with the microchannel 705. FIG. 7c clearly illustrates the simplicity of the device and also the size of the device is compared with a US quarter coin 707, to illustrate the extremely small dimensions that can be achieved by using this approach.

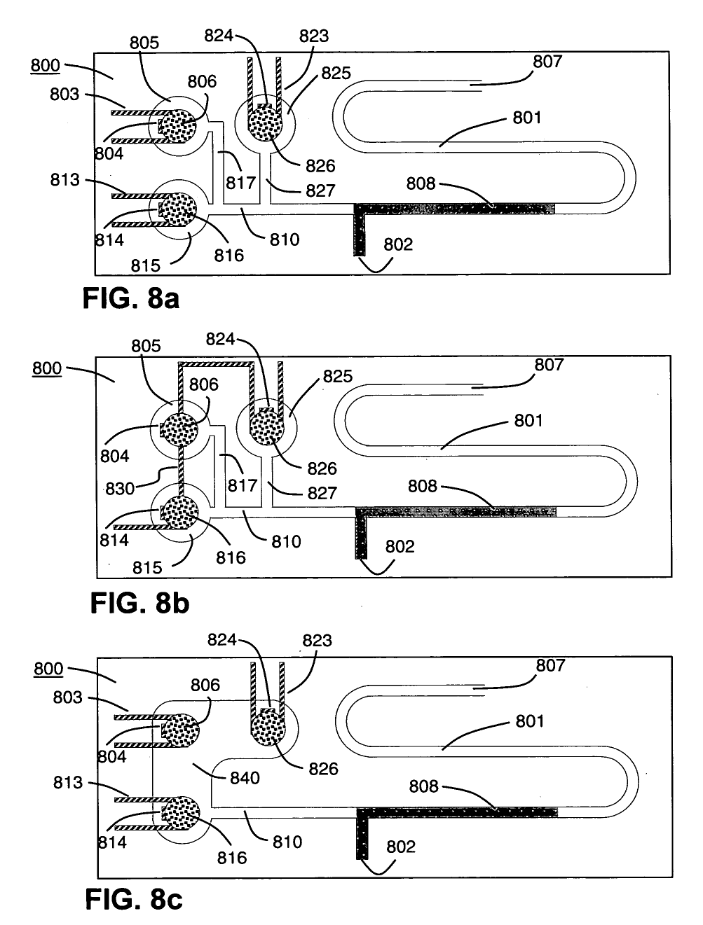

In order to generate a rapid pressure response the thickness of the solid propellant film should be minimized as far as possible. However, for a given area, minimizing thickness leads to reduction in the quantity of solid propellant and consequently volume of released gas. Alternatively, multiple solid propellant films can be deposited in the biochip as shown in FIGS. 8a-8c to achieve optimum response. In one envisaged design, a multitude of solid propellant films, 806, 816 and 826, are deposited on independently controlled heaters 804, 814 and 824. All the gas liberated by the solid propellant is coupled to the microchannel 810 for pushing the liquid 808 via coupling microchannels, 817 and 827. Using this arrangement, a large amount of gas can be generated very rapidly or alternately even larger quantities of gas can be generated using thick solid propellant films in all three locations. This arrangement also allows for sequential triggering of the solid propellant films to generate distinct motions of the liquid column. For biochip applications, the ability to move the liquid column in distinct steps with each step transporting the liquid to a predetermined location is of great relevance.

The basic concept of using multiple solid propellant films can be extended in many configurations. One such example is shown in FIG. 8b wherein all the three solid propellant films 806, 816 and 817 are simultaneously triggered since they are deposited on separate heaters yet the three heaters share a common electrical current path. Another example of this is shown in FIG. 8c wherein the three solid propellant films, positioned on independent heaters are housed within the same cavity 840 that connects to the microchannel 810 directly. By modifying the shape and/or volume of the cavity, the dynamic pressure response of the on-chip pressure generator is modified to suit desired requirements. In yet another envisaged design, a single or plurality of solid propellants can be used to push liquids simultaneously or sequentially through a multitude of microchannels.

As shown in FIGS. 8a-8c, the plurality of solid propellants can be composed of similar material or they may be composed of different solid propellant films in each cavity with similar or dissimilar dissociation temperature. Of course, the current waveform, may be different for various types of solid propellant materials in order to achieve simultaneous or sequential release of gas. All reasonably envisaged variations of these concepts are incorporated within the scope of the present invention.

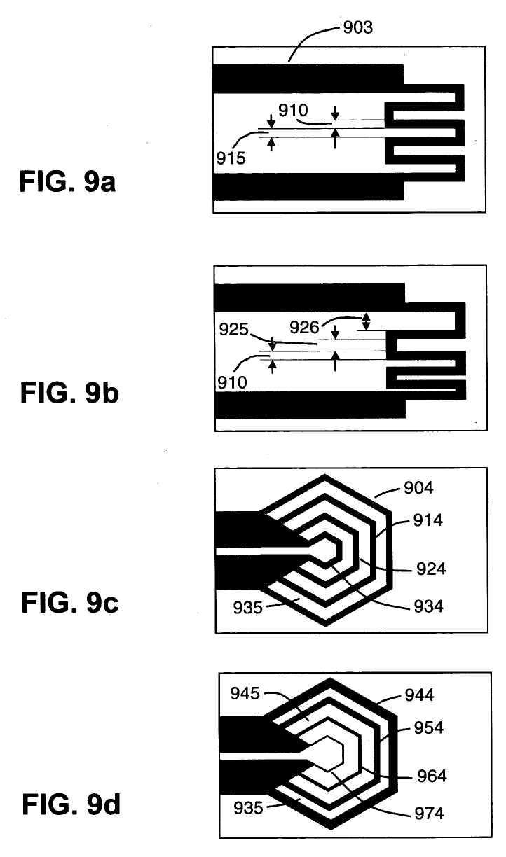

The dynamic pressure response of the on-chip pressure can also be regulated using various heater designs as illustrated in FIGS. 9a-9d. FIG. 9a shows the simplest possible microheater design where a simple heater pattern of meandering electrodes is defined using microfabrication techniques. In this design, the width 910 and the spacing 915 of the electrode tracks is uniform throughout the heater structure and this leads to a uniform heat flux across the entire structure. The dynamic response of the heater itself is governed by the dimensions (length, width, thickness and spacing) of the electrode pattern, the magnitude of the applied current and the nature of the current pulses. Generally, the contact lines 903 leading up to the microheater are much wider than the heater electrodes to ensure they have a low resistance and little power is lost across the contact lines. In typical designs, using gold microheaters, the resistance of the microheaters varies from 0.5 ohms to 25 ohms and the resistance of the contact lines varies from approximately 0.1 ohms to 5 ohms. A possible variation of this design is illustrated in FIG. 9b. In this design, the heater electrode width 910, is constant but the spacing 925, 926, changes between successive electrodes. As a result, in the design of FIG. 9b, the lower sections of the heater pattern will heat up faster and trigger the solid propellant. The solid propellant atop the top section of the heater will be heated after a brief delay and a slower gas release can be obtained.

Since the heater electrode pattern is defined using microfabrication techniques, it is possible to generate arbitrary designs for the microheater pattern. One such design is illustrated in FIG. 9c wherein multiple electrodes 904, 914, 924, and 934 of similar width and spacing 935 are arranged in parallel. This arrangement reduces the overall resistance of the heater and also the more uniform geometrical configuration would allow for controlled gas release. A possible variation of this design is illustrated in FIG. 9d wherein each of the electrodes has different widths. In this case, due to the smaller width (and consequently higher resistance), electrode 974 would heat up fastest followed by 964, and 954 and finally 944. Hence, in this case, the heat flux would radiate vertically as well as outwards allowing for controlled triggering of the solid propellant. For those skilled in the art, it is easy to design heater configurations that are different from these but are based on the concepts disclosed herein and all such reasonably envisaged designs are incorporated within the scope of the present invention.

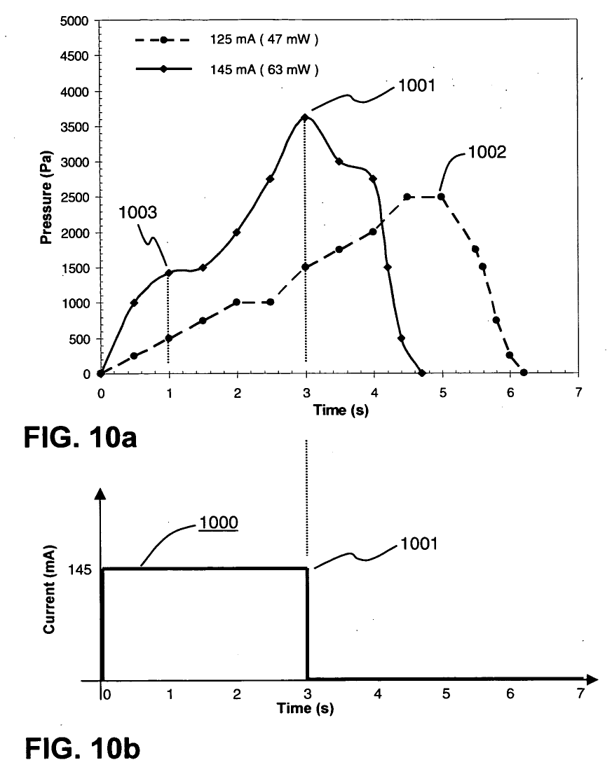

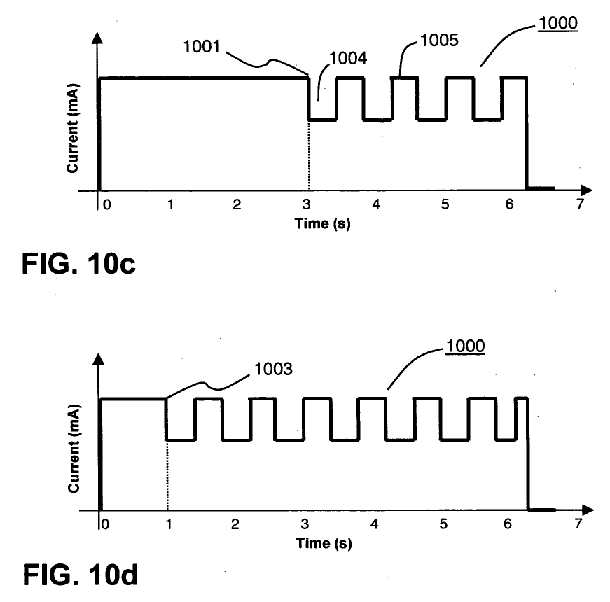

A significant advantage of the functional on-chip pressure source using solid propellants is the ability to generate programmable pressure response by modifying the nature and magnitude of the applied current pulse 1000 to the microheater. Hence, the pressure characteristics of the on-chip pressure generator can be described as dynamically controlled. FIG. 10a shows a typical pressure response of a 150 μm thick, 3.2 mm×3.2 mm AIBN solid propellant pressure generator, deposited on a triggered using different current magnitudes. As shown in FIG. 10a, when a higher current is applied, more Nitrogen gas is released rapidly and the pressure build up is faster. At times 1001 and 1002, the actuation current was switched off, as illustrated in FIG. 10b for the 145 mA case. The pressure then drops rapidly to the ambient pressure.

The dynamic pressure response shown in FIG. 10a was generated by applying a current pulse 1000 of the type shown in FIG. 10b. By using different current pulse configurations the dynamic pressure response can be easily modified. FIG. 10c illustrates one such example. In this case, the current pulse 1000 is held until 1001, to reach a certain pressure. After this, the current pulse 1000 is switched between a high 1005 and low 1004 value. Specifically, in this case the low value is higher than 0 hence the microheater does not cool down completely. If such current pulse with precisely controlled magnitude and frequency is applied to the microheater, the pressure characteristics (for the 145 mA case of FIG. 10a) will level out and hold at approximately the peak pressure (˜3700 Pa in this case) until all the solid propellant is exhausted or the current pulse is switched off. In yet another case, the applied current pulse 1000 is only held until 1003 and then toggled between high/low values. In this case, the pressure would be maintained at a lower value of approximately 1500 Pa. This description clearly highlights the tremendous flexibility offered by the functional on-chip pressure generator for dynamic pressure control. The term “functional” is used synonymously with “dynamically programmable” in this description and the meaning is readily apparent from the preceding description. This is critical for most microfluidic chips since, with accurate pressure control, the subsequent displacement and velocity of the liquid column can be accurately controlled. Even more changes in the dynamic pressure characteristics can be effected if the nature of the current pulse (i.e. square wave, triangular, sine wave etc.) is changed.

As described previously, the nature and magnitude of the applied current pulse 1000 strongly affects the dynamic pressure response of the on-chip pressure generator. The current pulse can be easily generated by a variety of different techniques that are well known in the art. Generally, the output of an electronic power controller (such as power regulator FET or transistor) is modulated using a second electronic controller which may be a dedicated electronic chip which generates the desired waveforms or a function generator or a PC based control program such as LabVIEW™. The microheater can be operated in an open loop or feedback loop configuration depending on the application. For feedback configuration, a second sensing electrode can be fabricated in close proximity of the microheater or the resistance change of the microheater itself can be monitored to sense the temperature of the heater.

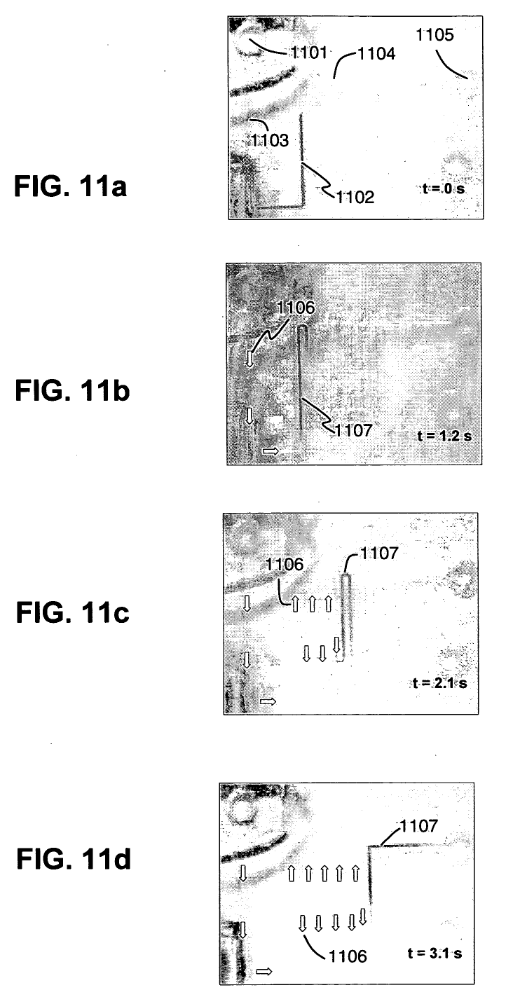

FIGS. 11a-11d, FIG. 12, and FIG. 13 present characterization and test results of the functional on-chip pressure generator using solid propellant. FIGS. 11a-11d show a microfluidic demonstration of the on-chip pressure source 1101, integrated with a microfluidic chip. Initially, a liquid plug 1102 is introduced and the liquid inlet is sealed (FIG. 11a). Then a pre-determined current pulse is applied to the microheater, triggering the solid propellant which releases nitrogen 1106. The released gas travels through the connecting channel 1103 and pushes the liquid column 1107 through the winding microchannel 1104 (FIG. 1b and FIG. 11c). Finally the liquid plug is ejected from the outlet 1105 within 3 seconds. Most microfabricated pumps would take considerably longer to displace the liquid column and would consume much more energy than the solid propellant based on-chip pressure source.

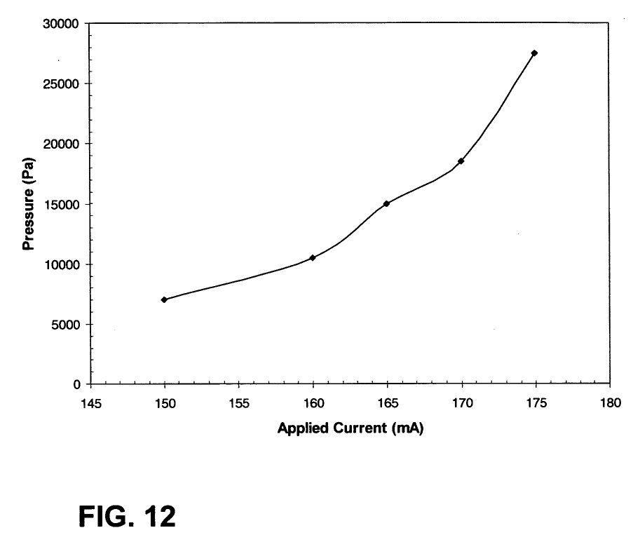

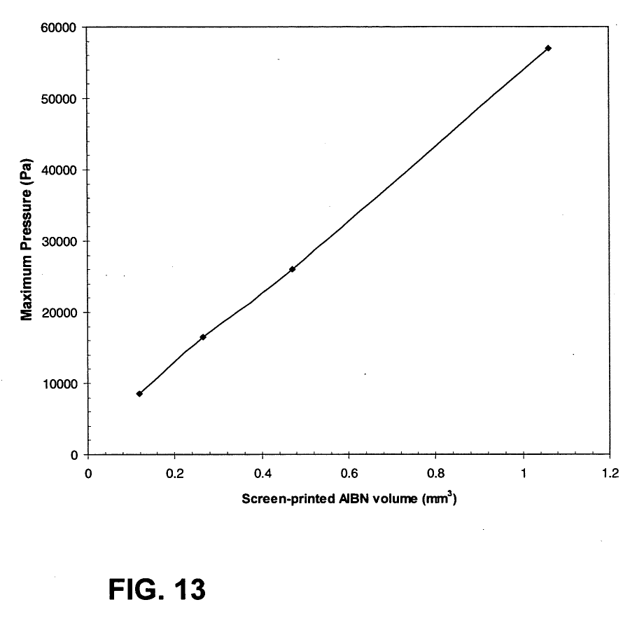

FIG. 12 shows characterization results for a 150 μm thick, 3.2 mm×3.2 mm AIBN solid propellant deposited using a TEFLON™ like matrix material over a microheater with approximately 10 ohms resistance within an approximately 8 μl sealed cavity. A constant current pulse is applied for the same duration for all cases. A pressure sensor is connected to the cavity to monitor the pressure changes but the gaseous components of dissociation have no escape path out of the cavity. As shown in FIG. 12, the output pressure can be easily governed by changing the magnitude of the applied current, hence affecting the heating of the microheater, which in turn governs the dissociation of the solid propellant. FIG. 13 shows characterization results showing the effect of change in solid propellant volume on maximum pressure generated within the 8 μl cavity using similar conditions, and also a constant current magnitude, as described for the previous test. As can be expected, higher volumes of solid propellant lead to higher maximum pressures since more gas is generated.

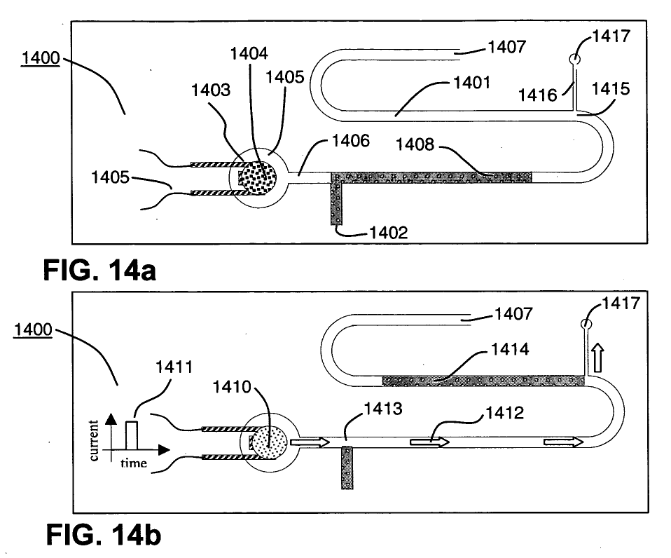

FIG. 14 illustrates the use of air vents 1417 in conjunction with the on-chip pressure generator for microfluidic manipulation with a biochip. In this configuration, a very coarse control can be used to regulate the triggering of the solid propellant. The liquid column 1414 travels through the microchannel 1401 due to applied pressure from the on-chip pressure generator 1410, and after a fixed displacement from 1413, the rear end of the liquid column crosses the air vent 1417. At this stage all the excess gas produced by the on-chip pressure source escapes from the air vent and the liquid column comes to rest at a precisely defined location. A multitude of air vents, which are sequentially closed, can also be used to move the liquid column is precisely defined steps.

Certain aforementioned embodiments of the functional on-chip pressure generator using solid propellants offer numerous advantages for microfluidic manipulation, a few of which are enumerated hereafter.

An advantage of certain embodiments of the present invention is the ability to fabricate a fully integrated pumping mechanism for microfluidic chips.

Another advantage of certain embodiments of the present invention is the ability to fabricate a functional on-chip pressure source using low-cost, mass-manufacturing techniques.

Yet another advantage of certain embodiments of the present invention is the ease of fabrication and integration with disposable microfluidic system.

Yet another advantage of certain embodiments of the present invention is the ability to manipulate fluids within a microfluidic chip using very low power actuation techniques.

Yet another advantage of certain embodiments of the present invention is to realize a reliable actuation scheme due to lack of moving parts in the actuation mechanism.

Yet another advantage of certain embodiments of the present invention is the ability to generate a precise pressure at any desired location on the biochip.

Yet another advantage of certain embodiments of the present invention is the ability to generate a controlled dynamic pressure response without any modifications to the fabricated device.

Yet another advantage of certain embodiments of the present invention is the ability to generate a wide variety of pressure response characteristics such as pressure spikes, or quasi-constant pressure using electronic control mechanisms.

Yet another advantage of certain embodiments of the present invention is the ability to generate a rapid response actuation scheme for microfluidic displacement on a biochip.

Yet another advantage of certain embodiments of the present invention is the ability to incorporate plurality of pumping sources on the same biochip. Furthermore, each pressure source can be independently or simultaneously triggered and each pressure source can generate a different pressure.

Yet another advantage of certain embodiments of the present invention is the ability to generate a wide range of gases, which may be biochemically active or inert, by choice of suitable solid propellant material.

Yet another advantage of certain embodiments of the present invention is the ability to fabricate the described on-chip pressure source on a wide range of substrates, some of which can offer a high degree of biocompatibility to physiological fluids.

To date, no pumping technique, feasible for operation on a microscale, has been demonstrated that offers the range of benefits offered by embodiments of the present invention. The use of solid propellants and the liberated gas thereof, directly for precise and programmable microfluidic manipulation is believed to be a novel concept and no examples of such approaches are known in the art to the applicant.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A pressure source for generating pressure in a micro-fluidic system, said pressure source comprising:
at least one micro-heater that is activated by electrical power; and
a solid chemical propellant based mixture being in thermal contact with said at least one micro-heater.

2. The pressure source of claim 1 further comprising a plastic substrate on which said at least one micro-heater is patterned.

3. The pressure source of claim 2 wherein said plastic substrate comprises at least one of polyimide, polymethylmethaacrylate, PDMS, polyethylene, polycarbonate and cyclic olefin copolymer.

4. The pressure source of claim 1 wherein said at least one micro-heater comprises a pattern of gold.

5. The pressure source of claim 1 wherein said solid chemical propellant based mixture comprises AIBN (azobis-isobutyronitrile) and spin-on teflon.

6. The pressure source of claim 1 wherein said mixture releases an inert gas when heated to a predetermined temperature by said micro-heater.

7. A method to fabricate a pressure source for generating pressure in a micro-fluidic system, said method comprising:
patterning a micro-heater onto a plastic substrate; and
depositing a solid chemical propellant based mixture onto said micro-heater.

8. The method of claim 7 further comprising integrating said plastic substrate with said micro-heater and said mixture into said micro-fluidic system.

9. The method of claim 7 wherein said plastic substrate is a layer within said micro-fluidic system.

10. The method of claim 7 wherein said micro-heater comprises a gold film.

11. The method of claim 7 wherein said mixture comprises AIBN (azobis-isobutyronitrile) and spin-on teflon.

12. The method of claim 7 wherein said patterning and said depositing are accomplished using a lithography/screen-printing technique.

13. The method of claim 8 wherein said integrating is accomplished using a UV curable epoxy bonding technique.

14. The method of claim 7 further comprising screen printing at least one conductive trace onto said plastic substrate such that said at least one conductive trace electrically connects to said micro-heater, wherein electrical power may be applied to said micro-heater via said at least one conductive trace.

15. The method of claim 7 wherein said plastic substrate comprises at least one of polyimide, polymethylmethaacrylate, PDMS, polyethylene, polycarbonate. and cyclic olefin copolymer.

16. The method of claim 7 wherein said mixture releases an inert gas into an air inlet of said micro-fluidic system to generate said pressure when said mixture is heated to a predetermined temperature by said micro-heater.

17. A method of using a pressure source in a micro-fluidic system, said method comprising:
applying electrical power to at least one micro-heater of said pressure source to cause a temperature of said at least one micro-heater to increase to at least a predetermined ignition temperature level;
transferring heat generated by said at least one micro-heater to a mixture of solid chemical propellant of said pressure source, said mixture being in thermal contact with said at least one micro-heater such that said mixture releases a gas; and
applying said gas to an inlet of said micro-fluidic system to create a pressure to move a fluid sample within said micro-fluidic system.

18. The method of claim 17 wherein said electrical power is applied via at least one conductive trace connected to said micro-heater.

19. The method of claim 17 wherein said mixture of solid chemical propellant comprises AIBN and spin-on teflon.

20. The method of claim 17 wherein said gas comprises nitrogen.

21. A functional or programmable pressure source used on a microfluidic chip, said pressure source comprising:
a solid propellant that evolves a precise quantity of gas upon heating beyond a critical dissociation temperature; and
a mechanism of heating said solid propellant above said dissociation temperature.
